(19) United States
(12) Patent Application Publication
(10) Pub. No.: US 2024/0234023 A1
(43) Pub. Date: Jul. 11, 2024

(54) COIL COMPONENT

(71) Applicant: SAMSUNG ELECTRO-MECHANICS CO., LTD., Suwon-si (KR)

(72) Inventors: Jong Pil LEE, Suwon-si (KR); Ic Seob KIM, Suwon-si (KR); Tai Yon CHO, Suwon-si (KR); No Il PARK, Suwon-si (KR); A Reum KIM, Suwon-si (KR)

(73) Assignee: SAMSUNG ELECTRO-MECHANICS CO., LTD., Suwon-si (KR)

(21) Appl. No.: 18/514,384

(22) Filed: Nov. 20, 2023

(30) Foreign Application Priority Data
Jan. 5, 2023 (KR) 10-2023-0001621

(51) Int. Cl. H01F 27/32; H01F 5/04; H01F 27/29

(52) U.S. Cl. CPC H01F 27/324; H01F 5/04; H01F 27/292

(57) ABSTRACT

A coil component includes a body having a first surface and a second surface, opposing each other in a first direction, a third surface and a fourth surface, opposing each other in a second direction, and a fifth surface and a sixth surface, opposing each other in a third direction, the body having a first recess and a second recess respectively formed in the first surface and the second surface, a coil disposed within the body, the coil including first and second lead-out portions respectively having at least portions extending to the first and second recesses, first and second external electrodes disposed on the sixth surface of the body to be spaced apart from each other, the first and second external electrodes respectively extending to the first and second recesses to be respectively connected to the first and second lead-out portions.

### CROSS-REFERENCE TO RELATED APPLICATION (S)

This application claims benefit of priority to Korean Patent Application No. 10-2023-0001621 filed on Jan. 5, 2023 in the Korean Intellectual Property Office, the disclosure of which is incorporated herein by reference in its entirety.

### TECHNICAL FIELD

The present disclosure relates to a coil component.

An inductor, a coil component, is a representative passive electronic component used in electronic devices, along with a resistor and a capacitor.

As electronic have gradually higher devices performance and reduced sizes, electronic components used in electronic devices has increased in number and reduced in size.

When individual chips are formed by dicing a coil bar, fine/coarse powder of a body thereof may be exposed due to friction with a dicing blade. After the fine/coarse powder of the body is exposed, the body may be covered through insulation coating. Insufficient insulation coating may result in plating spread (a plating defect) when external electrode plating is formed.

### SUMMARY

An aspect of the present disclosure is to control plating spread (a plating defect) when an electrode of a coil component is formed.

According to an aspect of the present disclosure, there is provided a coil component including a body having a first surface and a second surface, opposing each other in a first direction, a third surface and a fourth surface, opposing each other in a second direction, and a fifth surface and a sixth surface, opposing each other in a third direction, the body having a first recess and a second recess respectively formed in the first surface and the second surface, a coil disposed within the body, the coil including first and second lead-out portions respectively having at least portions extending to the first and second recesses, first and second external electrodes disposed on the sixth surface of the body to be spaced apart from each other, the first and second external electrodes respectively extending to the first and second recesses to be respectively connected to the first and second lead-out portions, and a first insulating layer disposed on the first to fifth surfaces of the body, the first insulating layer disposed on at least portions of the first and second external electrodes. The body may include a metal magnetic particles and a resin. The body may include an insulating film formed on a surface of the metal magnetic particles exposed to a surface of at least one of the first to fifth surfaces of the body.

According to the example embodiments of the present disclosure, plating spread (a plating defect) may be prevented when an electrode of a coil component is formed.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic view of a coil component according to a first example embodiment of the present disclosure;

FIG. 2 is a bottom view of a coil component according to a first example embodiment of the present disclosure in which some elements of the coil component are omitted;

FIG. 3 is a cross-sectional view taken along line I-I′ of FIG. 1;

FIG. 4 is a cross-sectional view taken along line II-II′ of FIG. 1;

FIG. 5 is an exploded view of a coil; and

FIG. 6 is an enlarged view of each of A and A′ of FIGS. 3 and 4.

### DETAILED DESCRIPTION

Terminology used herein is for the purpose of describing particular example embodiments only and is not to be limiting of the example embodiments. As used herein, the singular forms “a,” “an, ” and “the” are intended to include the plural forms as well, unless the context clearly indicates otherwise. As used herein, the term “and/or” includes any one and any combination of any two or more of the associated listed items. It will be further understood that the terms “comprises” and/or “comprising,” when used in this specification, specify the presence of stated features, integers, steps, operations, elements, components or combination thereof, but do not preclude the presence or addition of one or more other features, integers, steps, operations, elements, components, and/or groups thereof. In addition, the terms “disposed on,” “positioned on,” and the like, may mean the element is positioned on or below a target portion, and does not necessarily mean that the element is positioned on an upper side of the target portion with respect to a direction of gravity.

The terms “coupled to,” “connected to,” and the like, may not only indicate that elements are directly and physically in contact with each other, but also include a configuration in which another element is interposed between the elements such that the elements are also in contact with the other element.

The size and thickness of each element illustrated in the drawings is arbitrarily represented for ease of the description, but the present disclosure is not necessarily limited to those illustrated herein.

In the drawings, an X-direction may be defined as a first direction or an L direction, a Y-direction may be defined as a second direction or a W direction, and a Z-direction may be defined as a third direction or a T direction.

Hereinafter, a coil component according to some embodiments of the present disclosure will be described in detail with reference to the accompanying drawings. In the description with reference to the accompanying drawings, the same or corresponding elements are denoted by the same reference numerals and repeated descriptions thereof will be omitted.

Various types of electronic components may be used in electronic devices, and various types of coil components may be appropriately used between such electronic components to remove noise.

That is, in an electronic device, a coil component may be used as a power inductor, a high frequency (HF) inductor, a general bead, a high-frequency bead (GHz bead), a common mode filter, and the like.

### First Example Embodiment

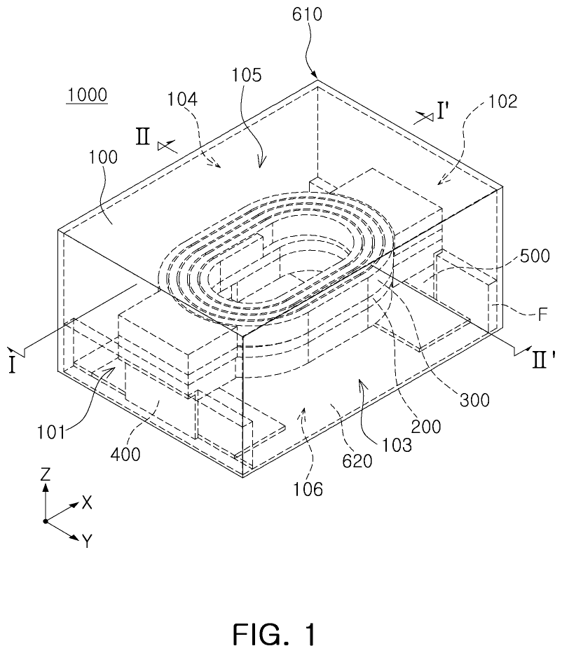

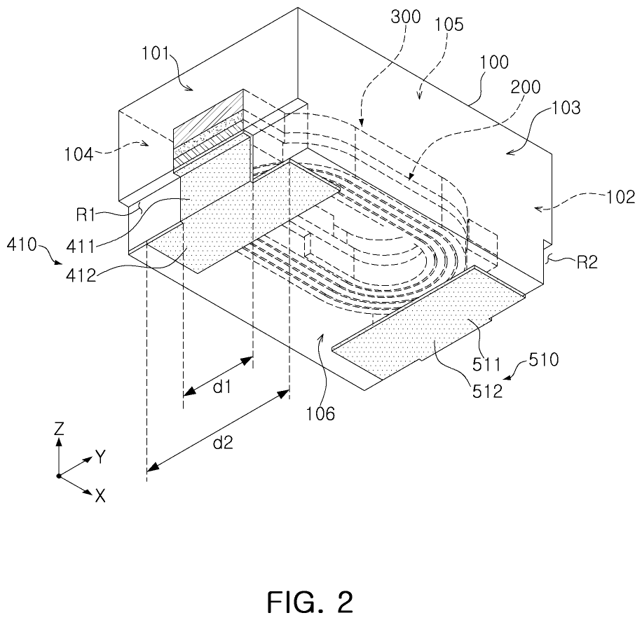

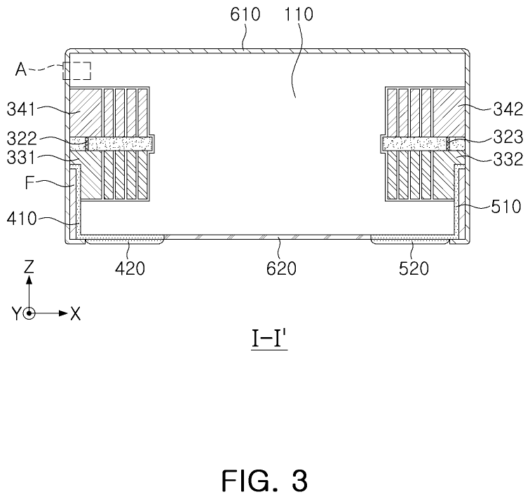

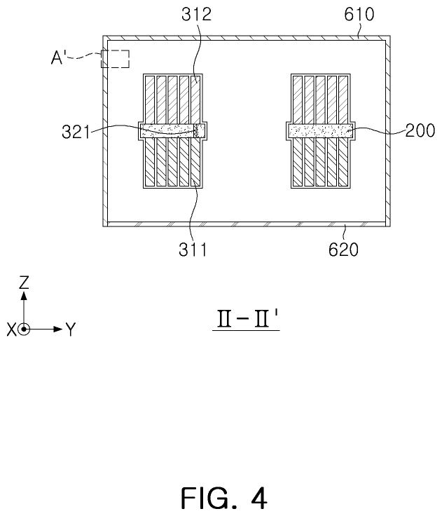

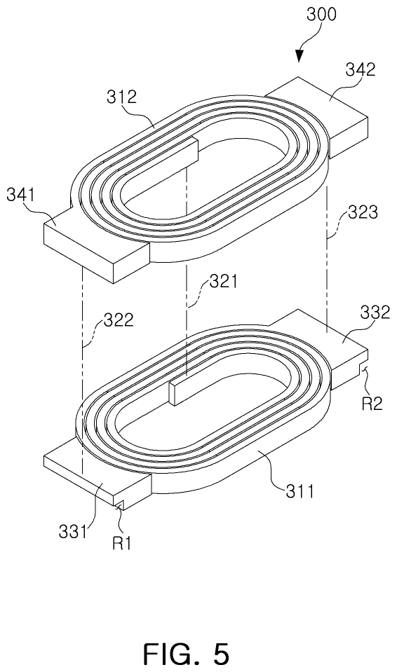

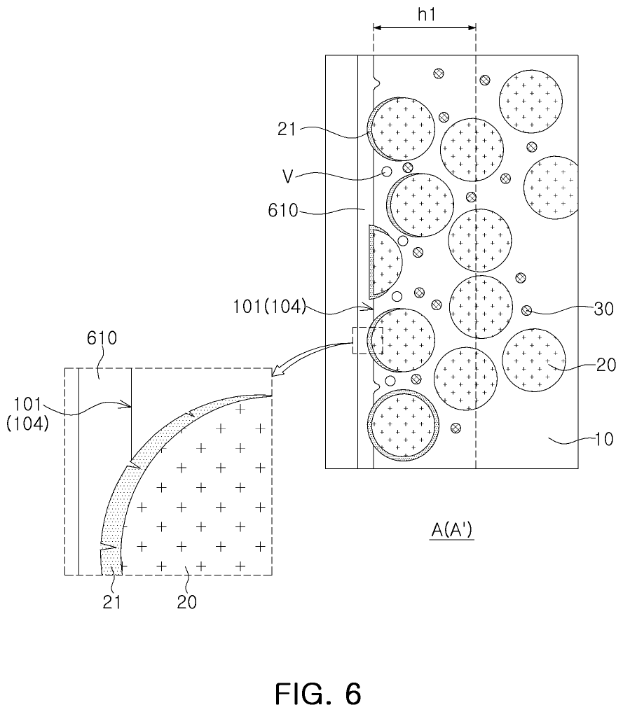

FIG. 1 is a schematic view of a coil component according to a first example embodiment of the present disclosure. FIG. 2 is a bottom view of the coil component according to the first example embodiment of the present disclosure in which some elements of the coil component are omitted. FIG. 3 is a cross-sectional view taken along line I-I′ of FIG. 1. FIG. 4 is a cross-sectional view taken along line II-II′ of FIG. 1. FIG. 5 is an exploded view of a coil. FIG. 6 is an enlarged view of each of A and A′ of FIGS. 3 and 4.

Referring to FIGS. 1 to 6, a coil component 1000 according to a first example embodiment of the present disclosure may include a body 100, a support substrate 200, a coil 300, external electrodes 400 and 500, an insulating layer 610, and an insulating film 21, and may further include a filling portion F and a second insulating layer 620.

The body 100 may form the exterior of the coil component 1000 according to the present example embodiment, and may include the coil 300 and the support substrate 200 disposed therein.

The body 100 may have an overall hexahedral shape.

The body 100, with respect to the directions of FIGS. 1 to 4, may have a first surface 101 and a second surface 102 opposing each other in an X-direction L, a third surface 103 and a fourth surface 104 opposing each other in a Y-direction W, and a fifth surface 105 and a sixth surface 106 opposing each other in a Z-direction T. The first to fourth surfaces 101, 102, 103, and 104 of the body 100 may respectively correspond to a surface of the body 100 connecting the fifth surface 105 and the sixth surface 106 of the body 100 to each other. Hereinafter, both end surfaces (one end surface and the other end surface) of the body 100 may refer to the first surface 101 and the second surface 102 of the body 100, both side surfaces (one side surface and the other side surface) of the body 100 may refer to the third surface 103 and the fourth surface 104 of the body 100, one surface of the body 100 may refer to the sixth side 106 of the body 100, and the other surface of the body 100 may refer to the fifth surface 105 of the body 100.

For example, the body 100 may be formed such that the coil component 1000 according to the some embodiments, including external electrodes 400 and 500 and insulating layers 610 and 620 to be described below, has a length of 2.0 mm, a width of 1.2 mm, and a thickness of 0.65 mm, but the present disclosure is not limited thereto. The above-described numerical values are merely design values which are not reflecting a process error, and the like, such that it should be considered that dimensions within a range admitted as a processor error fall within the scope of the present disclosure.

The body 100 may include a magnetic material and a resin. Specifically, the body 100 may be formed by laminating one or more magnetic composite sheets in which the magnetic material is dispersed in the resin. The magnetic material may include a magnetic material such as ferrite.

The magnetic material may include ferrite powder particles or metal magnetic particles.

The ferrite power particles may include, for example, at least one selected from the group consisting of spinel-type ferrite power particles such as Mg-Zn-based ferrite powder particles, Mn-Zn-based ferrite powder particles, Mn-Mg-based ferrite powder particles, Cu-Zn-based ferrite powder particles, Mg-Mn-Sr-based ferrite powder particles, Ni-Zn-based ferrite powder particles, or the like, hexagonal ferrite power particles such as Ba-Zn-based ferrite powder particles, Ba-Mg-based ferrite powder particles, Ba-Ni-based ferrite powder particles, Ba-Co-based ferrite powder particles, Ba-Ni-Co-based ferrite powder particles, or the like, garnet-type ferrite power particles such as Y-based ferrite power particles or the like, Li-based ferrite power particles and combinations thereof.

The magnetic metal power particles may include one or more selected from the group consisting of iron (Fe), silicon (Si), chromium (Cr), cobalt (Co), molybdenum (Mo), aluminum (Al), niobium (Nb), copper (Cu), and nickel (Ni). For example, the magnetic metal power particles may be at least one of pure iron powder particles, Fe-Si-based alloy power particles, Fe-Si-Al-based alloy power particles, Fe-Ni-based alloy power particles, Fe-Ni-Mo-based alloy power particles, Fe-Ni-Mo-Cu-based alloy power particles, Fe-Co-based alloy power particles, Fe-Ni-Co-based alloy power particles, Fe-Cr-based alloy power particles, Fe-Cr-Si-based alloy power particles, Fe-Si-Cu-Nb-based alloy power particles, Fe-Ni-Cr-based alloy power particles, Fe-Cr-Al-based alloy power particles, and combinations thereof.

The magnetic metal powder particles may be amorphous or crystalline. For example, the magnetic metal powder particles may include Fe-Si-B-Cr-based amorphous alloy powder particles, but the present disclosure is not necessarily limited thereto.

Each of the ferrite powder particles and the magnetic metal powder particles may have an average diameter of about 0.1 μm to about 30 μm, but the present disclosure is not limited thereto. An average diameter of the magnetic metal powder particles may refer to a particle size distribution of particles represented by D₉₀ or D₅₀.

The body 100 may include two or more types of magnetic materials dispersed in the resin. Here, different types of magnetic materials mean that the magnetic materials dispersed in the resin are distinguished from each other by one of an average diameter, a composition, crystallinity, and a shape.

The resin may include epoxy, polyimide, a liquid crystal polymer, or the like alone or in combination, but the present disclosure is not limited thereto.

The body 100 may include metal magnetic particles 20 and 30 and a resin 10, and may include an insulating film 21 formed on surfaces of the metal magnetic particles 20 and 30 exposed to side surfaces and a top surface of the body 100. Specifically, an insulating film may be formed on a surface of a metal magnetic particle exposed to at least one of the first to fifth surfaces 101, 102, 103, 104, and 105 of the body 100.

The magnetic metal powder particles 20 and 30 may include one or more selected from the group consisting of iron (Fe), silicon (Si), chromium (Cr), cobalt (Co), molybdenum (Mo), aluminum (Al), niobium (Nb), copper (Cu), and nickel (Ni) and combinations thereof. For example, the magnetic metal power particles 20 and 30 may include at least one selected from the group consisting of pure iron powder particles, Fe-Si-based alloy power particles, Fe-Si-Al-based alloy power particles, Fe-Ni-based alloy power particles, Fe-Ni-Mo-based alloy power particles, Fe-Ni-Mo-Cu-based alloy power particles, Fe-Co-based alloy power particles, Fe-Ni-Co-based alloy power particles, Fe-Cr-based alloy power particles, Fe-Cr-Si-based alloy power particles, Fe-Si-Cu-Nb-based alloy power particles, Fe-Ni-Cr-based alloy power particles, Fe-Cr-Al-based alloy power particles, and combinations thereof.

The magnetic metal powder particles 20 and 30 may be amorphous or crystalline. For example, the magnetic metal powder particles 20 and 30 may include Fe-Si-B-Cr-based amorphous alloy powder particles, but the present disclosure is not necessarily limited thereto. Each of the metal magnetic particles 20 and 30 may have an average diameter of about 0.1 μm to about 30 μm, but the present disclosure is not limited thereto.

The magnetic metal powder particles may include a first powder particle 20 and a second powder particle 30 having a particle diameter smaller than that of the first powder particle 20. As used herein, the particle diameter may refer to a particle size distribution represented by D₉₀ or D₅₀. In the present disclosure, the metal magnetic particles include the first powder particle 20 and the second powder particle 30 having a particle diameter smaller than that of the first powder particle 20, such that the second powder particle 30 may be dispersed in a space between the first powder particles 20. As a result, a filling rate of the magnetic material in the body 100 may be improved. In the description below, for ease of description, it is assumed that the metal magnetic particles the body 100 include the first powder particle 20 and the second powder particle 30 having different particle diameters, but the present disclosure is not limited thereto. As another non-limiting example of the present disclosure, the metal magnetic particles may include three types of powder particles having different particle diameters.

The insulating film 21 may be formed on surfaces of the metal magnetic particles 20 and 30 exposed to at least one of the first to fifth surfaces 101, 102, 103, 104, and 105 of the body 100. The metal magnetic particles 20 and 30 may be exposed to the first to fifth surfaces 101, 102, 103, 104, and 105 of the body 100 through a full dicing process for individualizing a coil bar. In particular, the first to fourth surfaces 101, 102, 103, and 104 of the body 100 may correspond to cut surfaces in the full dicing process, and accordingly the metal magnetic particles 20 and 30, present across a dicing line, may be cut, such that a cut surface thereof may be exposed to the first to fourth surfaces 101, 102, 103, and 104 of the body 100. That is, in the process of polishing a magnetic body cut into individual chip sizes, fine/coarse metal magnetic particles may be exposed. Accordingly, when an external electrode plating layer is on the body 100, plating spread may occur in that a plating layer is formed on a magnetic powder from which an insulating coating layer is peeled off.

Accordingly, in the coil component according to the some embodiments, the insulating film 21, having excellent electrical insulation, may be formed on surfaces of the metal magnetic particles 20 and 30 exposed to at least one of the first to fifth surfaces of the body, such that plating spread may be controlled when the external electrodes 400 and 500 are plated.

An insulating material may be used as a material for forming the insulating film 21. For example, the insulating film 21 may be an oxide insulating film including at least one selected from the group consisting of iron (Fe), aluminum (Al), silicon (Si), titanium (Ti), magnesium (Mg), chromium (Cr), zinc (Zn), phosphorus (P), boron (B), combinations thereof.

The insulating film 21 may be formed on surfaces of the metal magnetic particles 20 and 30 exposed to the first to fifth surfaces 101, 102, 103, 104, and 105 of the body 100, using an immersion method.

Specifically, when the insulating film 21 include an oxide insulating film, acid treatment may be performed on the metal magnetic particles 20 and 30 exposed through the first to fifth surfaces 101, 102, 103, 104, and 105 of the body 100 to form the insulating film 21. In this case, an acid treatment solution may selectively react with the exposed metal magnetic particles 20 and 30 to form the insulating film 21, such that the insulating film 21 may include a metal component of the exposed metal magnetic particles 20 and 30. The insulating film 21 may be formed on the first to fifth surfaces 101, 102, 103, 104, and 105 of the body 100 through acid treatment, thereby reducing the number of processes, as compared to a case in which a patterned insulating layer is formed on the first to fifth surfaces 101, 102, 103, 104, and 105 of the body 100.

Alternatively, the insulating film 21 may be formed through a phosphate coating using such as zinc phosphate, iron phosphate, manganese phosphate or the like, or an organic coating using such as an epoxy or the like. Specifically, the insulating film 21 may be formed by treating the metal magnetic particles 20 and 30 exposed to the first to fifth surfaces 101, 102, 103, 104, and 105 of the body 100 with a phosphate solution. The body 100 may be immersed in the phosphate solution and dried, and then heat treatment may be performed thereon at a temperature of 180° C. or higher. In this case, the insulating film 21 may include phosphate-based glass, and may include, for example, one or more selected from the group consisting of iron phosphate salt, zinc phosphate salt, manganese phosphate salt, and combination thereof.

Due to a relatively porous structure of a cured product of the resin 10 of the body 100, the solution may permeate from the first to fifth surfaces 101, 102, 103, 104, and 105 of the body 100 to a predetermined depth h1. As a result, the insulating film 21 may be formed not only on the metal magnetic particles 20 and 30 having a surface exposed to the first to fifth surfaces 101, 102, 103, 104, and 105 of the body 100 but also on at least portions of the metal magnetic particles 20 and 30 having a surface not exposed to the first to fifth surfaces 101, 102, 103, 104, 105 of the body 100 but dispersed within the predetermined depth h1 from the first to fifth surfaces 101, 102, 103, 104, 105 of the body 100. That is, the insulating film 21 may be formed on at least portions of the first and second metal magnetic particles 20 and 30 disposed within the predetermined depth h1 from the first to fifth surfaces 101, 102, 103, 104, and 105 of the body 100. In addition, a thickness of the insulating film 21 may be less than 5 μm. Here, the predetermined depth from the first to fifth surfaces 101, 102, 103, 104, and 105 of the body 100 may be defined as a depth of about 0.5 times the particle diameter of the first metal magnetic particle 20 described above.

The thickness of the insulating film 21 may be associated with capacitance of the coil component 1000, together with a thickness of a first insulating layer 610 to be described below, and accordingly will be described in detail when the first insulating layer 610 is described.

The particle diameter of the first metal magnetic particle 20 may be larger than the particle diameter of the second metal magnetic particle 30, such that the insulating film 21 may be generally formed on a surface of the first metal magnetic particle 20. That is, both the first powder particle 20 and the second metal magnetic particle 30 may be disposed within a predetermined depth from the first to fifth surfaces 101, 102, 103, 104, and 105 of the body 100. However, when an acid treatment is performed, the second powder particle 30 may be dissolved in an acid treatment solution due to a relatively small particle diameter of the second powder particle 30. The second powder particle 30 may be dissolved in the acid treatment solution to form a void V in a region within the predetermined depth from the first to fifth surfaces 101, 102, 103, 104, and 105 of the body 100. As a result, the void V, having a volume corresponding to a volume of the second powder particle 30, may remain in the resin 10 disposed within the predetermined depth from the first to fifth surfaces 101, 102, 103, 104, and 105 of the body 100. As described above, the particle diameter of the second powder particle 30 may refer to a particle diameter according to a particle diameter distribution D₅₀ or D₉₀, and accordingly the volume of the second powder particle 30 may also refer to a volume distribution. Accordingly, the volume of the void V, corresponding to the volume of the second powder particle 30, may mean that a volume distribution of the void V is substantially the same as a volume distribution of the second powder particle 30.

The insulating film 21 may be formed when at least portions of surfaces of the metal magnetic particles 20 and 30 are exposed to a surface of the body 100 or the metal magnetic particles 20 and 30 disposed within a predetermined depth from the surface of the body 100 react with a solution. Accordingly, the insulating film 21 may be discontinuously formed on the surface of the body 100.

As illustrated in FIG. 6, with respect to one metal magnetic particle 20 or 30 disposed within a predetermined depth from the first to fifth surfaces 101, 102, 103, 104, and 105 of the body 100, the insulating film 21 may be formed on an entire surface of the metal magnetic particle 20 or 30, or may be formed only in one region of a surface of the metal magnetic particle 20 or 30.

The insulating film 21 may also be formed on surfaces of the metal magnetic particles 20 and 30 exposed to bottom surfaces and portions of the internal walls of first and second recesses R1 and R2. Specifically, the insulating film 21 may not be formed on surfaces of the metal magnetic particles 20 and 30 exposed to regions of the bottom surfaces and internal walls of the first and second recesses R1 and R2 to be described below in which the external electrodes 400 and 500 are disposed. This may be a result of forming connection portions 411 and 511 of the external electrodes on the bottom surfaces and internal walls of the recesses R1 and R2 using plating before a full dicing process for individualizing a coil bar. That is, as first metal layers 410 and 510 of the external electrodes are formed before the full dicing process, the insulating film 21 may not be formed on surfaces of portions of the metal magnetic particles 20 and 30 exposed to the first and second recesses R1 and R2

The insulating film 21 may not be formed on surfaces of the metal magnetic particles 20 and 30 exposed to the sixth surface 106 of the body 100.

The body 100 may include a core 110 passing through a central portion of each of the support substrate 200 and the coil 300 to be described below. The core 110 may be formed by filling a through-hole passing through a central portion of each of the coil 300 and the support substrate 200 with a magnetic composite sheet, but the present disclosure is not limited thereto.

The first and second recesses R1 and R2 may be formed on the first and second surfaces 101 and 102 of the body 100, respectively. Specifically, the first recess R1 may be positioned at an edge between the first surface 101 and the sixth surface 106 of the body 100, the second recess R2 of the body 100 may be located at an edge between the second surface 102 and the sixth surface 106. The first and second recesses R1 and R2 may have a depth (a length of each of the first and second recesses in a Z-direction) at which lead-out portions 331 and 332 of the coil 100 to be described below are exposed to internal surfaces of the first and second recesses R1 and R2. However, the first and second recesses R1 and R2 may not extend to the fifth surface 105 of the body 100. That is, the first and second recesses R1 and R2 may not pass through the body 100 in the Z-direction. In other words, the first and second recesses R1 and R2 may need to expose the lead-out portions 331 and 332 to the internal surface of the first and second recesses R1 and R2, respectively for connection between the lead-out portions 331 and 332 to be described below and the external electrodes 400 and 500, respectively. Accordingly, the depth of each of the first and second recesses R1 and R2 may have a value greater than or equal to that of a distance from at least one surface of the body 100 to each of the lead-out portions 331 and 332, respectively.

The first and second recesses R1 and R2 may extend to the third and fourth surfaces 103 and 104 of the body 100 in a Y-direction (second direction) of the body 100, respectively. That is, the first and second recesses R1 and R2 may be in the form of a slit formed in the Y-direction (second direction) of the body 100. The first and second recesses R1 and R2 may be formed on a coil bar level, a state before each coil component is individualized, by performing pre-dicing on one surface of the coil bar along a boundary line corresponding to a width direction of each coil component, among boundary lines for individualizing each coil component. The depths of the first and second recesses R1 and R2 when pre-dicing is performed may be adjusted such that the lead-out portions 331 and 332 are exposed, respectively.

The internal surfaces (internal walls and bottom surfaces) of the recesses R1 and R2 may also form a surface of the body 100. However, as used herein, the internal surfaces of the recesses R1 and R2 may be distinguished from the surface of the body 100 for ease of description. In addition, FIGS. 1 to 3 illustrate that the first and second recesses R1 and R2 have internal walls parallel to the first and second surfaces 101 and 102 of the body 100, and bottom surfaces parallel to the fifth and sixth surfaces 105 and 106 of the body 100. However, such a configuration is for ease of description, and the present example embodiment is not limited thereto. For example, the internal surface of the first recess R1 may be in the form of a curve connecting the first surface 101 and the sixth surface 106 of the body with respect to an X-direction (first direction) -Z-direction (third direction) cross-section (X-Z cross-section) of the coil component 1000 according to the present example embodiment. However, hereinafter, for ease of description, it will be described that the recesses R1 and R2 have internal walls and bottom surfaces.

The support substrate 200 may be disposed within the body 100. The support substrate 200 may be configured to support the coil 300 to be described below.

The support substrate 200 may include at least one selected from the group consisting of an insulating material including a thermosetting insulating resin such as epoxy resin, a thermoplastic insulating resin such as polyimide, or a photosensitive insulating resin, or an insulating material in which a reinforcing material such as a glass fiber or an inorganic filler is impregnated with an insulating resin. For example, the support substrate 200 may be formed of an insulating material such as prepreg, an Ajinomoto build-up film (ABF), FR-4, a bismaleimide triazine (BT) resin, a photoimageable dielectric (PID), or the like, or may be formed using a metal laminate such as a copper clad laminate (CCL), but the present disclosure is not limited thereto.

The inorganic filler include at least one selected from the group consisting of silica (SiO₂), alumina (Al₂O₃), silicon carbide (SiC), barium sulfate (BaSO₄), talc, mud, mica powder, aluminum hydroxide (Al(OH)3), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), calcium zirconate (CaZrO₃), and combinations thereof.

When the support substrate 200 includes an insulating material including a reinforcing material, the support substrate 200 may provide more excellent rigidity. When the support substrate 200 includes an insulating material including no glass fiber, it may be advantageous in reducing a thickness of the coil component 1000 according to some embodiments. When the support substrate 200 include an insulating material including a photosensitive insulating resin, the number of processes of forming the coil 300 may be reduced. Thus, it may be advantageous in reducing production costs, and fine vias 321 and 322 may be formed.

The coil 300 may be disposed on the support substrate 200 within the body 100 to exhibit properties of the coil component 1000. For example, when the coil component 1000 according to some embodiments of the present disclosure is used as a power inductor, the coil 300 may serve to stabilize power of an electronic device by storing an electric field as a magnetic field and maintaining an output voltage.

The coil 300 may include coil patterns 311 and 312, vias 321, 322 and 323, lead-out portions 331 and 332, and auxiliary lead-out portions 341 and 342. Specifically, with respect to the directions of FIGS. 1 to 4, a first coil pattern 311, a first lead-out portion 331, and a second lead-out portion 332 may be disposed on a lower surface of the support substrate 200 which faces toward the sixth surface 106 of the body 100, and a second coil pattern 312, a first auxiliary lead-out portion 341, and a second auxiliary lead-out portion 321 may be disposed on an upper surface of the support substrate 200 which is an opposite surface from the lower surface of the support substrate 200. The first coil pattern 311 may be disposed on the lower surface of the support substrate 200 to be spaced apart from the first lead-out portion 331 and be in contact with the second lead-out portion 332. The second coil pattern 312 may be disposed on the upper surface of the support substrate 200 to be in contact with the first auxiliary lead-out portion 341 and be spaced apart from the second auxiliary lead-out portion 342. The first via 321 may pass through the support substrate 200 to be connected to an internal end of each of the first coil pattern 311 and the second coil pattern 312. The second via 322 may pass through the support substrate 200 to be contact-connected to each of the first lead-out portion 331 and the first auxiliary lead-out portion 341. The third via 323 may pass through the support substrate 200 to be contact-connected to each of the second lead-out portion 332 and the second auxiliary lead-out portion 342. As a result, the coil 300 may function as a single coil.

Each of the first coil pattern 311 and the second coil pattern 312 may have a planar spiral shape in which at least one turn is formed using the core 110 as an axis. For example, the first coil pattern 311 may form at least one turn on the lower surface of the support substrate 200, using the core 110 as an axis.

At least portions of the first lead-out portion 331 and the second lead-out portion 332 may extend to and is in contact with internal surfaces of the first and second recesses R1 and R2, respectively. Specifically, at least a portion of the first lead-out portion 331 may extend to the internal surface of the first recess R1, and at least a portion of the second lead-out portion may extend to the internal surface of the second recess R2. The connection portions 411 and 511 of the external electrodes 400 and 500 to be described below may be disposed in the first and second recesses R1 and R2, such that the coil 300 and the external electrodes 400 and 500 may be contact-connected to each other. Hereinafter, for ease of description, as illustrated in FIGS. 1 to 3, it is described that the first and second recesses R1 and R2 respectively extend into at least portions of the lead-out portions 331 and 332, and accordingly the lead-out portions 331 and 332 respectively extend to internal walls and bottom surfaces of the first and second recesses R1 and R2. However, such a configuration is merely exemplary, and the present disclosure is not limited thereto. That is, depths of the first and second recesses R1 and R2 may be adjusted such that the lead-out portions 331 and 332 extend only to the bottom surfaces of the first and second recesses R1 and R2, respectively. When the lead-out portions 331 and 332 extend to both the bottom surfaces and the internal walls of the first and second recesses R1 and R2, a contact area between the lead-out portions 331 and 332 and connection portions 411 and 511 of the external electrodes 400 and 500 may increase, such that bonding force between the coil 300 and the external electrodes 400 and 500 may increase.

One surfaces of the lead-out portions 331 and 332 extending to the internal surfaces of the first and second recesses R1 and R2, respectively, may have a surface roughness higher than that of other surfaces of the lead-out portions 331 and 332, which do not extend to the internal surfaces of the first and second recesses R1 and R2. For example, when the lead-out portions 331 and 332 are formed by electroplating and then the first and second recesses R1 and R2 are formed, portions of the lead-out portions 331 and may be removed in a slit formation process. As a result, the one surfaces of the lead-out portions 331 and 332 extending to the internal surfaces of the first and second recesses R1 and R2 may be formed to have surface roughness higher than that of the other surfaces of the lead-out portions 331 and 332 due to polishing of a dicing tip. As will be described below, the external electrodes 400 and 500 may be formed of a thin film, and accordingly may have relatively weak bonding force with the coil 300. The external electrodes 400 and 500 may be contact-connected to the one surfaces of the lead-out portions 331 and 332 having relatively high surface roughness, and accordingly bonding force between the external electrodes 400 and 500 and the lead-out portions 331 and 332 may be improved.

The lead-out portions 331 and 332 and the auxiliary lead-out portions 341 and 342 extend to the first and second surfaces 101 and 102 of the body 100, respectively. That is, the first lead-out portion 331 may extend to the first surface 101 of the body 100, and the second lead-out portion 332 may extend to the second surface 102 of the body 100. The first auxiliary lead-out portion 341 may extend to the first surface 101 of the body 100, and the second auxiliary lead-out portion 342 may extend to the second surface 102 of the body 100. As a result, as illustrated in FIGS. 1 to 3, the first lead-out portion 331 may continuously extend to the internal wall of the first recess R1, the bottom surface of the first recess R1, and the first surface of the body 100, and the second lead-out portion 332 may continuously extend to the internal wall of the second recess R2, the bottom surface of the second recess R2, and the second surface 102 of the body 100.

At least one of the coil patterns 311 and 312, the vias 321, 322 and 323, the lead-out portions 331 and 332, and the auxiliary lead-out portions 341 and 342 may include at least one conductive layer.

For example, when the second coil pattern 312, the auxiliary lead-out portions 341 and 342, and the vias 321, 322, and 323 are formed on one surface of the support member 200 using plating, each of the second coil pattern 312, the auxiliary lead-out portions 341 and 342, and the vias 321, 322, and 323 may include a seed layer and an electroplating layer. Here, the electroplating layer may have a single-layer structure or a multilayer structure. The electroplating layer, having a multilayer structure, may be formed to have a conformal film structure in which one electroplating layer is formed on another electroplating layer, and may be formed to have a shape in which one electroplating layer is laminated only on one surface of another electroplating layer. The seed layer may be formed using a vapor deposition method such as electroless plating or sputtering. The seed layer of the second coil pattern 312, the second layer of the auxiliary lead-out portions 341 and 342, and the seed layer of the vias 321, 322, and 323 may be formed integrally with each other, such that no boundaries therebetween may be formed, but the present disclosure is not limited thereto. The electroplating layer of the second coil pattern 312, the electroplating layer of the auxiliary lead-out portions 341 and 342, and the electroplating layer of the vias 321, 322, and 323 may be formed integrally with each other, such that no boundaries therebetween may be formed, but the present disclosure is not limited thereto.

For another example, the first coil pattern 311 and the lead-out portions 331 and 332 disposed on the lower surface of the support substrate 200, and the second coil pattern 312 and the auxiliary lead-out portions 341 and 342 disposed on the upper surface of the support substrate 200 are formed separately from each other and then collectively laminated on the support substrate 200 to form the coil 300. The vias 321, 322, and 323 may include a low melting point metal layer having a melting point lower than a melting point of a high melting point metal layer. Here, the low melting point metal layer may be formed of solder including lead (Pb) and/or tin (Sn). At least a portion of the low melting point metal layer may be melted due to pressure and temperature when collectively laminated, and accordingly, an inter metallic compound layer (IMC Layer) may be formed at a boundary between the low melting point metal layer and the second coil pattern 312, for example.

For example, as illustrated in FIGS. 3 and 4, the coil patterns 311 and 312, the lead-out portions 331 and 332, and the auxiliary lead-out portions 341 and 342 may be respectively formed to protrude from the lower and upper surfaces of the support substrate 200. For another example, the first coil pattern 311 and the lead-out portions 331 and 332 may be formed to protrude from the lower surface of the support substrate 200, and the second coil pattern 312 and the auxiliary lead-out portions 341 and 342 may be buried in the upper surface of the substrate 200, and accordingly may have upper surfaces exposed to the upper surface of the support substrate 200. In this case, concave portions may be formed on the upper surface of the second coil pattern 312 and/or on the upper surfaces of the auxiliary lead-out portions 341 and 342, such that the upper surface of the support substrate 200 and the upper surface of the second coil pattern 312 and/or the upper surfaces of the auxiliary lead-out portions 341 and 342 may not be positioned on the same plane.

Each of the coil patterns 311 and 312, the vias 321, 322, and 323, the lead-out portions 331 and 332, and the auxiliary lead-out portions 341 and 342 may include a conductive material such as copper (Cu), aluminum (Al), silver (Ag), tin (Sn), gold (Au), nickel (Ni), lead (Pb), titanium (Ti), or alloys thereof, but the present disclosure is not limited thereto.

The external electrodes 400 and 500 may be disposed on the sixth surface 106 of the body to be spaced apart from each other, and may respectively extend to the first and second recesses R1 and R2, respectively, to be in contact with the first and second lead-out portions 331 and 332. In some embodiments of the present disclosure, the first external electrode 400 may include a first metal layer 410 and a second metal layer 420, and the second external electrode 500 may include a first metal layer 510 and a second metal layer 520. The first metal layers 410 and 510 may include connection portions 411 and 511, respectively, disposed in the recesses R1 and R2 to be in contact with the lead-out portions 331 and 332 extending to the internal surfaces of the recesses R1 and R2, and extension portions 412 and 512 disposed on the sixth side 106 of 100. The second metal layers 420 and 520 may be disposed on the extension portions 412 and 512 of the first metal layers 410 and 510. Specifically, the first metal layer 410 of the first external electrode 400 may include a first connection portion 411 disposed on the bottom surface and internal wall of the first recess R1 to be contact-connected to the first lead-out portion 331 of the coil 300, and a first extension portion 412 disposed on the sixth surface 106 of the body 100, and the second metal layer 420 of the first external electrode 400 may be disposed on the first extension portion 412 of the first metal layer 410. The first metal layer 510 of the second external electrode 500 may include a second connection portion 511 disposed on the bottom surface and the internal wall of the second recess R2 to be contact-connected to the second lead-out portion 332 of the coil 300, and a second extension portion 512 disposed on the sixth surface 106 of the body 100, and the second metal layer 520 of the second external electrode 500 may be disposed on the second extension portion 512 of the first metal layer 510. The extension portions 412 and 512 of the external electrodes 400 and 500 may be disposed on the sixth surface 106 of the body 100 to be spaced apart from each other, and the second metal layers 420 and 520 of the external electrodes 400 and 500 may be disposed on the sixth surface 106 of the body 100 to be spaced apart from each other.

The first metal layers 410 and 510 may be formed along the bottom surfaces and internal walls of the recesses R1 and R2 and the sixth surface 106 of the body 100. That is, the first metal layers 410 and 510 may be in the form of a film conformal to the internal surfaces of the recesses R1 and R2 and the sixth surface 106 of the body 100.

The first metal layers 410 and 510 may be formed on the bottom surfaces and internal walls of the recesses R1 and R2 and on the sixth surface 106 of the body 100 using plating before a full dicing process for individualizing a coil bar. That is, the first metal layers 410 and 510 may be formed using plating before fine/coarse metal magnetic particles are exposed by the full dicing process, thereby controlling plating spreading.

The connection portions 411 and 511 and the extension portions 412 and 512 of the first metal layers 410 and 510 may be formed together using the same process, such that the internal surfaces of the recesses R1 and R2 and the sixth surface 106 of the body 100 may be integrally formed. That is, no boundaries between the connection portions 411 and 511 and the extension portions 412 and 512 may be formed.

The connection portions 411 and 511 of the external electrodes 400 and 500, respectively, may be disposed on central portions of the first and second recesses R1 and R2 to be spaced apart from the third and fourth surfaces 103 and 104 of the body 100, respectively. That is, the connection portions 411 and 511 may be disposed on central portions in a Y-direction (second direction) of the internal surfaces of the first and second recesses R1 and R2, respectively. The lead-out portions 331 and 332 may extend to the central portions in the Y-direction (second direction) of the internal surfaces of the first and second recesses R1 and R2, respectively, such that the connection portions 411 and 511 may be formed only in regions of the internal surfaces of the first and second recesses R1 and R2 in which the lead-out portions 331 and 332 extend.

The extension portions 412 and 512 of the external electrodes 400 and 500, respectively, may be disposed on the sixth surface 106 of the body 100 to be spaced apart from the third and fourth surfaces 103 and 104 of the body 100, respectively. In this case, the coil component 1000 according to some embodiments of the present disclosure may be prevented from being short-circuited with other components mounted on an outside in the Y-direction (second direction) of a mounting board or the like.

At least one of distances from the third and fourth surfaces 103 and 104 of the body 100 to the extension portions 412 and 512 may be shorter than at least one of distances from the third and fourth surfaces 103 and 104 of the body 100 to the connection portions 411 and 511, respectively. For example, a length d1 in the Y-direction (second direction) of each of the connection portions 411 and 511 may be shorter than a length d2 in the Y-direction (second direction) of each of the extension portions 412 and 512. The sixth surface 106 of the body 100 may be used as a mounting surface when the coil component 1000 according to some embodiments of the present disclosure is mounted on a mounting board or the like, and the second metal layers 420 and 520 disposed on the extension portions 412 and 512 of the external electrodes 400 and 500, respectively, may be connected to each other via a coupling member such as a connection pad, solder, and the like of the mounting board. In this case, the length d2 in the Y-direction (second direction) of each of the extension portions 412 and 512 may be longer than the length d1 in the Y-direction (second direction) of each of the connection portions 411 and 511, such that a length in the Y-direction (second direction) of each of the second metal layers 420 and 520 in contact with the coupling member such as solder or the like may be increased. In addition, the length d1 in the Y-direction (second direction) of each of the connection portions 411 and 511 may be shorter than the length d2 in the Y-direction (second direction) of each of the extension portions 412 and 512, thereby preventing a short-circuit with other components mounted on the mounting board to be adjacent in the X-direction (first direction). That is, among elements of the external electrodes 400 and 500, each of the connection portions 411 and 511, disposed to be most adjacent to other components in the X direction (first direction) during mounting, may be formed to have a small size (length in the Y-direction (second direction)), thereby reducing the possibility of a short-circuit with other components.

The second metal layers 420 and 520 may be disposed on the extension portions 412 and 512. Specifically, the second metal layer 420 of the first external electrode 400 may be disposed on the first extension portion 412, and the second metal layer 520 of the second external electrode 500 may be disposed on the second extension portion 512. The second metal layer 520 may be formed after the full dicing process, and may be formed using plating after the insulating film 21 and the first insulating layer 610 to be described below are formed. The second metal layers 420 and 520 may have a single-layer structure or a multilayer structure. For example, the second metal layers 420 and 520 may be sequentially formed, using plating, on the extension portions 412 and 512, including copper (Cu), respectively. Each of the second metal layers 420 and 520 may include a nicker (Ni) plating layer including nickel (Ni) and a tin (Sn) plating layer including tin (Sn), but the present disclosure is not limited thereto.

The external electrodes 400 and 500 may be formed using a vapor deposition method such as sputtering or the like and/or a plating method, but the present disclosure is not limited thereto.

The external electrodes 400 and 500 may include a conductive material such as copper (Cu), aluminum (Al), silver (Ag), tin (Sn), gold (Au), nickel (Ni), lead (Pb), chromium (Cr), titanium (Ti), or alloys thereof, but the present disclosure is not limited thereto.

A coil insulating film may be disposed between the coil 300 and the body 100 and between the support substrate 200 and the body 100. The coil insulating film may be formed along surfaces of the lead-out portions 331 and 332, the coil patterns 311 and 312, the support substrate 200, and the auxiliary lead-out portions 341 and 342, but the present disclosure is not limited thereto. The coil insulating film may be used to insulate the coil 300 and the body 100 from each other, and may include a known insulating material such as parylene, but the present disclosure is not limited thereto. For another example, the coil insulating layer may include an insulating material such as an epoxy resin other than parylene. The coil insulating film may be formed using a vapor deposition method, but the present disclosure is not limited thereto. For another example, the coil insulating film may be formed by laminating and curing an insulating film for forming a coil insulating film on both surfaces of the support substrate 200 on which the coil 300 is formed, and may be formed by coating and curing an insulating paste for forming a coil insulating film on both surfaces of the support substrate 200 on which the coil 300 is formed. For the reasons described above, the coil insulating film may be omitted in some embodiments of the present disclosure. That is, when the body 100 has sufficient electrical resistance at a designed operating current and voltage of the coil component 1000 according to the present example embodiment, the coil insulating film may be omitted in the present example embodiment.

The first insulating layer 610 may be disposed on the first to fifth surfaces 101, 102, 103, 104, and 105 of the body 100, and may be disposed on at least portions of the first and second external electrodes 400 and 500. The first insulating layer 610 may be disposed on the connection portions 411 and 511 of the first and second external electrodes 400 and 500, and the first insulating layer 610 may expose at least portions of the extension portions 412 and 512 of the first and second external electrodes 400 and 500.

The first insulating layer 610 may be directly disposed on the connection portions 411 and 511 of the external electrodes 400 and 500, but may be disposed on the filling portion F to be described below, filling at least portions of the first and second recesses R1 and R2, and accordingly may not be directly disposed on the connection portions 411 and 511. However, the filling portion F may be omitted in some embodiments of the present disclosure, and accordingly the first insulating layer 610 may be expressed as being disposed on the connection portions 411 and 511, for ease.

In addition, the first insulating layer 610 may be directly disposed on the internal surfaces of the first and second recesses R1 and R2, but may be disposed on the filling portion F to be described below, filling at least portions of the first and second recesses R1 and R2, and accordingly may not be directly disposed on inner surfaces of the first and second recesses R1 and R2. However, the filling portion F may be omitted in some embodiments of the present disclosure, and accordingly the first insulating layer 610 may be expressed as being disposed on the first and second recesses R1 and R2, for ease.

The first insulating layer 610 may be disposed on the sixth surface 106 of the body 100. In this case, the first insulating layer 610 may expose at least portions of the extension portions 412 and 512 of the first and second external electrodes 400 and 500.

In plating the second metal layers 420 and 520 of the external electrodes 400 and 500, the first insulating layer 610 may function as a plating resist, together with the second insulating layer 620 to be described below. Accordingly, the first insulating layer 610 may be formed on the body 100 to cover the connection portions 411 and 511 and open the extension portions 412 and 512 after the first metal layers 410 and 510 of the external electrodes 400 and 500 are formed, and accordingly may define a region in which the second metal layers 420 and 520 are to be formed, together with the second insulating layer 620. However, the present disclosure is not limited thereto.

The first insulating layer 610 may include thermoplastic resin such as a polystyrene-based resin, a vinyl acetate-based resin, a polyester-based resin, a polyethylene-based resin, a polypropylene-based resin, a polyamide-based resin, a rubber-based resin, an acrylic-based resin, or the like, a thermosetting resin such as a phenol-based resin, an epoxy-based resin, an urethane-based resin, a melamine-based resin, an alkyd-based resin, or the like, a photosensitive resin, parylene, SiOₓ(0<x<2) or SiNₓ(0<x<2).

The first insulating layer 610 may have an adhesive function. For example, when the first insulating layer 610 is formed by performing a lamination process on an insulating film, the insulating film may include an adhesive component to adhere to the body 100. In this case, an adhesive layer may be formed on one surface of the first insulating layer 610. However, as in a case in which the first insulating layer 610 is formed using a B-stage insulating film, an adhesive layer may not be formed on one surface of the first insulating layer 610.

The first insulating layer 610 may be formed by coating a liquid insulating resin, coating an insulating paste, laminating an insulating film, or performing vapor deposition. Alternatively, the first insulating layer 610 may be formed by disposing a material for forming a surface insulating layer on a silicon die or the like and then stamping the body 100 on the silicon die. A dry film (DF) including a photosensitive insulating resin, an ABF or a polyimide film including no photosensitive insulating resin may be used as the insulating film.

A thickness of the first insulating layer 610 may be 5 μm or more. When the thickness of the first insulating layer 610 is less than 5 μm, it may be difficult to protect the exterior and secure quality (visibility). That is, the thickness of the first insulating layer 610 for coating a surface of a coil component at a uniform thickness may be about 5 μm. However, the thickness of the first insulating layer 610 is not necessarily limited thereto, and the first insulating layer 610 of the coil component 1000 according to the present example embodiment may have a thickness of less than 5 μm.

A sum of thicknesses of the first insulating layer 610 and the insulating film 21 may be 10 μm or less. When the sum of the thicknesses of the first insulating layer 610 and the insulating film 21 is greater than 10 μm, a total length, width, and thickness of the coil component may increase, which may be disadvantageous a reduction in thickness, and an effective volume of a magnetic material may decrease as compared to a component having the same volume, resulting in poor component properties. That is, the sum of the thicknesses of the first insulating layer 610 and the insulating film 21 may not need to be greater than 10 μm, which is a thickness required to control plating spread only with insulating layer coating according to the related art, thereby securing sufficient capacitance.

The thickness of the insulating film 21 may be less than 5 μm. That is, as described above, in the case of the first insulating layer 610, a preferred thickness for protecting the exterior and securing quality may be 5 μm or more. The sum of the thicknesses of the first insulating layer 610 and the insulating film 21 may be required to be 10 μm or less due to component properties, such that the thickness of the insulating film 21 may be less than 5 μm.

As a method of measuring the thicknesses of the insulating film 21 and the first insulating layer 610, a cut surface of the body 100 may be measured using a micro microscope, an optical microscope, a scanning electron microscope (SEM), or the like.

Specifically, the insulating film 21 may also be formed on the metal magnetic particles 20 and 30 disposed within a predetermined depth from the first to fifth surfaces 101, 102, 103, 104, and 105 of the body 100. In this case, a distance from an external surface of the body 100 to the predetermined depth may be defined as the thickness of the insulating film 21. The thickness of the insulating film 21 may be obtained by taking a sample of a cut surface of the body 100 in an X-Z direction and measuring a distance from the external surface of the body to the metal magnetic particles 20 and 30 on which the insulating film 21 is formed. The thickness of the first insulating layer 610 may

be obtained by measuring a thickness of the body 100 without the first insulating layer 610 and measuring a thickness of the body 100 with the first insulating layer 610 formed thereon, and then comparing the thicknesses to each other.

In this case, the thicknesses of the insulating film 21 and the first insulating layer 610 may refer to values measured once or may refer to an arithmetic average of values measured a plurality of times.

Subsequently, Table 1 shows whether to satisfy exterior properties and product thickness properties according to the thickness of the insulating film 21.

TABLE 1

| | Thickness (μm) | | |
|---|---|---|---|
| | of Insulating | Exterior | Product Thickness |
| No. | Film 21 | Properties | Properties |
| 1 | 0 | Unsatisfactory | Satisfactory |
| 2 | 1.0 | Satisfactory | Satisfactory |
| 3 | 2.0 | Satisfactory | Satisfactory |
| 4 | 3.0 | Satisfactory | Satisfactory |
| 5 | 4.0 | Satisfactory | Satisfactory |
| 6 | 5.0 | Satisfactory | Unsatisfactory |

According to Table 1, when there was no insulating film 21, a defect occurred in the exterior due to external electrode plating spread. When the insulating film 21 was 5 μm or more, the sum of the thicknesses of the insulating film 21 and the first insulating layer 610 may be greater than 10 μm, such that a product thickness considering coil component properties was satisfied.

The second insulating layer 620 may be disposed on the sixth surface 106 of the body 100, and may expose the extension portions 412 and 512. The second insulating layer 620 may be disposed on outsides of both ends in the Y-direction (second direction) of each of the extension portions 412 and 512, such that the extension portions 412 and 512 may be disposed to be respectively spaced apart from the third and fourth surfaces 103 and 104 of the body 100. The second insulating layer 620 may prevent the coil component 1000 according to the present example embodiment from being short-circuited with other components mounted to be adjacent in the Y-direction (second direction). In addition, when the coil component 1000 according to the present example embodiment is mounted on a mounting board or the like, the second insulating layer 620 may prevent an increase in effective mounting area occupied by the coil component 1000 mounted on the mounting board due to a size occupied by a coupling member such as solder or the like.

For example, the second insulating layer 620 may be formed on the sixth surface 106 of the body 100 before the external electrodes 400 and 500 are formed. Accordingly, the second insulating layer 620 may function as a mask formed when the first metal layers 410 and 510 of the external electrodes 400 and 500 are selectively formed on the sixth surface 106 of the body 100 and on the internal surfaces of the first and second recesses R1 and R2. For example, the second insulating layer 620 may function as a plating resist when the first metal layers 410 and 510 of the external electrodes 400 and 500 are formed using a plating method.

The second insulating layer 620 may be collectively formed on each coil component at a coil bar level, a state before each coil component is individualized. That is, a process of forming the second insulating layer 620 may be performed between the above-described pre-dicing process and individualization process (full dicing process).

The second insulating layer 620 may be formed of a thermoplastic resin such as a polystyrene-based resin, a vinyl acetate-based resin, a polyester-based resin, a polyethylene-based resin, a polypropylene-based resin, a polyamide-based resin, a rubber-based resin, an acrylic-based resin, or the like, a thermosetting resin such as a phenol-based resin, an epoxy-based resin, an urethane-based resin, a melamine-based resin, an alkyd-based resin, or the like, a photosensitive resin, parylene, SiOₓ(0<x<2) or SiNₓ(0<x<2), but the present disclosure is not limited thereto. The second insulating layer 620 may further include an insulating filler such as an inorganic filler, but the present disclosure is not limited thereto. The second insulating layer 620 may be formed by laminating an insulating film on the sixth surface 106 of the body 100, coating and curing an insulating paste, or vapor-depositing an insulating material, but the present disclosure is not limited thereto.

Thus, in the coil component 1000 according to the present example embodiment, only a relatively simple insulating structure may be formed in the body 100 in which the recesses R1 and R2 are formed, thereby increasing an effective volume of a magnetic material as compared to the same component size. As a result, component properties such as inductance and the like may be improved.

The coil component 1000 according to the present example embodiment may further include the filling portion F. The filling portion F may fill at least portions of the recesses R1 and R2 and cover the connection portions 411 and 511 of the external electrodes. That is, the connection portions 411 and 511 of the external electrodes may be disposed between the filling portion F and the internal surfaces of the recesses R1 and R2, and the filling portion F may be in contact with the connection portions 411 and 511 of the external electrodes.

In addition, in this case, the first insulating layer 610 may cover the filling portion F, and the first insulating layer 610 may not be in direct contact with the connection portions 411 and 511 of the external electrodes.

One surface of the filling portion F may be disposed on substantially the same plane as each of the first and second surfaces 101 and 102 of the body 100. For example, the first metal layers 410 and 510 of the external electrodes may be formed in a coil bar state, a space between adjacent bodies may be filled with a material for forming a filling portion, and then full dicing may be performed, such that the one surface of the filling portion F may be disposed on substantially the same plane as each of the first to fourth surfaces 101, 102, 103, and 104 of the body 100.

The filling portion F may include an insulating resin. The insulating resin may include epoxy, polyimide, a liquid crystal polymer, or the like alone or in combination, but the present disclosure is not limited thereto.

The filling portion F may further include magnetic powder particles dispersed in the insulating resin. The magnetic powder particles may be ferrite powder particles or metal magnetic particles.

The ferrite power particles may include, for example, at least one selected from the group consisting of spinel-type ferrite power particles such as Mg-Zn-based ferrite powder particles, Mn-Zn-based ferrite powder particles, Mn-Mg-based ferrite powder particles, Cu-Zn-based ferrite powder particles, Mg-Mn-Sr-based ferrite powder particles, Ni-Zn-based ferrite powder particles, or the like, hexagonal ferrite power particles such as Ba-Zn-based ferrite powder particles, Ba-Mg-based ferrite powder particles, Ba-Ni-based ferrite powder particles, Ba-Co-based ferrite powder particles, Ba-Ni-Co-based ferrite powder particles, or the like, garnet-type ferrite power particles such as Y-based ferrite power particles or the like, and Li-based ferrite power particles.

The magnetic metal power particles may include one or more selected from the group consisting of iron (Fe), silicon (Si), chromium (Cr), cobalt (Co), molybdenum (Mo), aluminum (Al), niobium (Nb), copper (Cu), and nickel (Ni). For example, the magnetic metal power particles may be at least one of pure iron powder particles, Fe-Si-based alloy power particles, Fe-Si-Al-based alloy power particles, Fe-Ni-based alloy power particles, Fe-Ni-Mo-based alloy power particles, Fe-Ni-Mo-Cu-based alloy power particles, Fe-Co-based alloy power particles, Fe-Ni-Co-based alloy power particles, Fe-Cr-based alloy power particles, Fe-Cr-Si-based Fe-Si-Cu-Nb-based alloy power alloy power particles, particles, Fe-Ni-Cr-based alloy power particles, and Fe-Cr-Al-based alloy power particles.

The magnetic metal powder particles may be amorphous or crystalline. For example, the magnetic metal powder particles may include Fe-Si-B-Cr-based amorphous alloy powder particles, but the present disclosure is not necessarily limited thereto.

Each of the ferrite powder particles and the magnetic metal powder particles may have an average diameter of about 0.1 μm to about 30 μm, but the present disclosure is not limited thereto.

While example embodiments have been shown and described above, it will be apparent to those skilled in the art that modifications and variations could be made without departing from the scope of the present disclosure as defined by the appended claims.

What is claimed is:

1. A coil component comprising:
a body having a first surface and a second surface, opposing each other in a first direction, a third surface and a fourth surface, opposing each other in a second direction, and a fifth surface and a sixth surface, opposing each other in a third direction, the body having a first recess and a second recess respectively formed in the first surface and the second surface;
a coil embedded in the body, the coil including first and second lead-out portions respectively having at least portions extending to and being in contact with the first and second recesses;
first and second external electrodes disposed on the sixth surface of the body to be spaced apart from each other, first and second external electrodes respectively extending to and being in contact with the first and second recesses through which being connected to the first and second lead-out portions; and
a first insulating layer disposed on the first to fifth surfaces of the body, the first insulating layer disposed on at least portions of an outer surface of the first and second external electrodes,
wherein the body includes a metal magnetic particle and a resin,
an insulating film is disposed on at least a part of a surface of the metal magnetic particle, and
the at least the part of the surface of the metal magnetic particle is exposed to a surface of at least one of the first to fifth surfaces of the body.

2. The coil component of claim 1, wherein a thickness of the insulating film is less than 5 μm.

3. The coil component of claim 2, wherein a sum of thicknesses of the insulating film and the first insulating layer is 10 μm or less.

4. The coil component of claim 3, wherein a thickness of the first insulating layer is 5 μm or more.

5. The coil component of claim 1, wherein the insulating film includes an oxide insulating film.

6. The coil component of claim 1, wherein the insulating film includes phosphate-based glass.

7. The coil component of claim 6, wherein the phosphate-based glass includes one or more selected from the group consisting of iron phosphate salt, zinc phosphate salt, and manganese phosphate salt.

8. The coil component of claim 1, wherein
each of the first and second external electrodes includes a connection portion disposed in the first and second recesses being in contact with the first and second lead-out portions, and an extension portion disposed on the sixth surface of the body, and
the first insulating layer is disposed on the connection portion.

9. The coil component of claim 8, wherein the first insulating layer exposes at least a portion of the extension portion.

10. The coil component of claim 1, wherein the at least the part of the surface of the metal magnetic particle where the insulating film is disposed includes a surface of the metal magnetic particle exposed to portions of internal surfaces of the first and second recesses and the first and second surfaces of the body.

11. The coil component of claim 10, wherein the at least the part of the surface of the metal magnetic particle where the insulating film is disposed includes on a surface of the metal magnetic particle exposed to the third to fifth surfaces of the body.

12. The coil component of claim 8, further comprising:
a second insulating layer disposed on the sixth surface of the body and not disposed on the extension portion.

13. The coil component of claim 1, further comprising:
a filling portion filling at least a portion of each of the first and second recesses,
wherein the filling portion is in contact with at least a portion of the external electrode.

14. The coil component of claim 13, wherein the first insulating layer disposed on at least a portion of an outer surface of the filling portion.
